(19) United States
(12) Patent Application Publication
(10) Pub. No.: US 2024/0250998 A1
(43) Pub. Date: Jul. 25, 2024

(54) ACCESS CONTROL DATA EVALUATION SYSTEMS, METHODS, AND APPARATUSES

(71) Applicant: Schlage Lock Company LLC, Carmel, IN (US)

(72) Inventors: Donald L. Beene, Westfield, IN (US); Michael McCracken, Highlands Ranch, CO (US)

(21) Appl. No.: 18/419,692

(22) Filed: Jan. 23, 2024

Related U.S. Application Data
(60) Provisional application No. 63/481,253, filed on Jan. 24, 2023.

(51) Int. Cl. H04L 9/40

(52) U.S. Cl. CPC H04L 63/205; H04L 63/102; H04L 63/1425

(57) ABSTRACT

The present disclosure is directed to systems, components, and methods for evaluating access control data stored and/or collected by access control systems for security assessments and/or anomaly detection in the use of one or more access control devices at a location.

### CROSS-REFERENCE TO RELATED APPLICATION

The present application claims the benefit of the filing date of U.S. Provisional Application Ser. No. 63/481,253 filed on Jan. 24, 2023, which is incorporated herein by reference.

### BACKGROUND

Access control systems can be used to electronically access buildings and other facilities. These access control systems can be configured to store information regarding the system settings and various access actions that have occurred that can be reviewed by lock owners and administrators as an audit or use history. While this information can be useful, it is not evaluated or synthesized and therefore important or desired security information may be missed or may not be timely provided. Therefore, further improvements are needed for evaluating this data to improve access control monitoring and administration.

### SUMMARY

Embodiments of the present disclosure are directed to unique systems, components, and methods for evaluating access control data stored and/or collected by access control systems for security assessments and/or anomaly detection. Other embodiments are directed to apparatuses, systems, devices, hardware, methods, and combinations thereof for leveraging such data for access control administration, awareness, and for improving the security of locations secured by the access control systems.

According to an embodiment, a method of access control data evaluation for an access control system may include collecting, by the access control system, access control data regarding usage of the access control system at a location, generating at least one of a security assessment and an anomaly detection at the location based at least in part on usage of the access control system, and outputting the at least one of the security assessment and anomaly detection for use by an administrator of the access control system. The administrator may be, for example, the facility owner, a homeowner, a parent, a manager, a user of the access control system, security personnel, an access control device provider, a third party security provider or facility manager, a licensee, an and/or a lessee.

In some embodiments, the security assessment may include security scores and/or security recommendations based on an analysis of the access control data.

In some embodiments, generating at least one of the security assessment and the anomaly detection may include analyzing the access control data using machine learning of patterns of usage of one or more access control devices based on the access control data.

In some embodiments, the access control system includes multiple access control devices at the location that secure various areas within the location, and the security assessment and/or anomaly detection is performed across the multiple access control devices.

In some embodiments, the generates security assessment is aggregated across multiple access control devices for the access control system at the location.

In some embodiments, the security assessment include a security score that is based on an analysis of access control data including system parameters such as system configuration, tenure of access privileges, volume of access privileges, usage of access privileges, usage history at an access point/access control device, installation history, and security score/stability. In some embodiments, the security assessment includes a security recommendation that may include, for example, one or more of increasing or changing a locked duration of the access control device(s), changing times during which the access control device(s) are locked and/or are unlockable by certain users, enabling one or more security features, and reviewing or pruning access privileges by credentialed users.

In some embodiments, the anomaly detection includes, based on an analysis of existing access control data, detecting access or attempted access by an uncredentialed or a credentialed user at an access point, detecting access or attempted access by a credentialed user at an unauthorized time, detecting access or attempted access by a credentialed user at an unauthorized access point, detecting access or attempted access by a user with expired credentials, detecting a frequency of access or attempted access by a credentialed or uncredentialed user, and/or detecting a lack of access or attempted access by a credentialed user at an access point and/or at a predetermined time.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of an system for security assessment and anomaly detection for an access control system;

FIG. 2 is a simplified block diagram of at least one embodiment of a computing system; and

FIG. 3 is a simplified flow diagram of at least one embodiment of a method for security assessment of an access control system.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

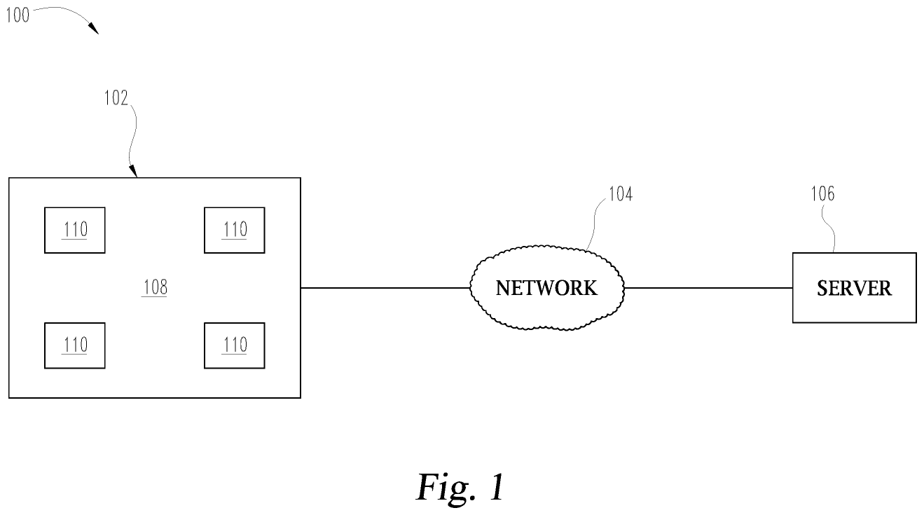

Referring now to FIG. 1, in the illustrative embodiment, a system 100 for obtaining and evaluating access control data for security assessments and/or anomaly detection in an access control system is shown. The illustrative system 100 includes an access control system 102, a network 104, and a server 106. Further, the illustrative access control system includes 102 is associated with a location 108 that includes a number (one or more) of access control devices 110 each at an associated access point within the location 108. The access control device(s) 110 may be associated with a door, window, or other access point into an area at the location 108, and are configured to collect and record access control data at each access point for subsequent analysis to provide security assessments and/or anomaly detection. A security assessment may include, for example, a security score associated with the access device or across multiple access devices 110 at the location 108, and one or more recommendations to improve security and/or the security score. Anomaly detection may include analyzing usage history patterns to detect behavior and/or events that deviate from a learned pattern of usage of one or more of the access control devices 110. The security assessments and reports of anomalies detected can be output to an administrator of the access control system 102 on a periodic basis automatically without prompting, or generated upon request. Anomaly detection can also be output to the administrator immediately upon the detection of an anomaly.

It should be appreciated that the access control system 102, access control device(s) 110, and/or the server 106 may be embodied as any type of device or collection of devices suitable for performing the functions described herein. More specifically, in the illustrative embodiment, the access control system 102 and/or access control devices 110 may be embodied as any type of device or collection of devices suitable for communicating, via wired or wireless connection (e.g., via Wi-Fi circuitry), with the network 104 and otherwise performing the functions described herein. For example, in some embodiments, the access control system 102 and/or access control device(s) 110 may be embodied as an electronic lock (e.g., a mortise lock, a cylindrical lock, or a tubular lock), an exit device (e.g., a pushbar or pushpad exit device), a door closer, an auto-operator, a motorized latch/bolt (e.g., for a sliding door), barrier control device (e.g., battery-powered), a peripheral controller of a passageway, credential reader device, and/or other type of access control device. As such, in some embodiments, the access control system 102 and/or access control device(s) 110 may include, or be electrically coupled to, a physical lock mechanism configured to control access through a passageway and/or other components typical of a lock device. For example, the lock mechanism may include a deadbolt, a latch bolt, a lever, and/or other mechanism adapted to move between a locked state and an unlocked state. In some embodiments, the access control system 102 and/or access control device(s) 110 may be stationary or have fixed movements (e.g., as with a fixed path of a door-mounted device).

In some embodiments, the access control system 102 and/or access control device(s) 110 may include one or more sensors configured to generate sensor data (e.g., by virtue of one or more signals), which may be interpreted by a processor of the access control system 102 and/or access control device(s) 110 as access control data to determine one or more characteristics of the security assessment and/or anomaly detection associated with the access control system 102 and/or access control device(s) 110. For example, in various embodiments, the sensors may detect various characteristics of the physical environment (e.g., internal and/or external to the access control system 102 and/or access control device 110), electrical characteristics, electromagnetic characteristics, of the access control system 102 and/or access control device 110 and/or their surroundings, and/or other suitable characteristics. In particular, the access control device 110 may include a door position sensor configured to generate sensor data (e.g., by virtue of one or more signals) associated with a door position status, which may be interpreted by the access control system 102 and/or access control device(s) 110 to determine whether the door is in a closed position or an open position, and/or a latchbolt sensor configured to generate sensor data (e.g., by virtue of one or more signals) associated with a latchbolt status, which may be interpreted to determine whether the latchbolt is in an extended position or a retracted position. In various embodiments, additional and/or alternative sensors other than those described above may be included in the access control system 102 and/or access control device(s) 110. For example, the sensors may include environmental sensors (e.g., temperature sensors, air pressure sensors, humidity sensors, light sensors, etc.), inertial sensors (e.g., accelerometers, gyroscopes, etc.), magnetometers, proximity sensors, optical sensors, electromagnetic sensors, audio sensors (e.g., microphones), motion sensors, cameras, piezoelectric sensors, pressure sensors, switches (e.g., reed switches), and/or other types of sensors.

The access control system 102 and/or access control device(s) 110 may include any one or more access points that, individually or collectively, allow wired or wireless communication devices (e.g., the access control devices 110) to connect to a wired network and/or the Internet (e.g., via the network 104). For example, in some embodiments, the access point(s) may be embodied as a gateway device that is communicatively coupled to a router. In other embodiments, the access point(s) may form an integral component of or otherwise form a portion of the router itself. Further, in some embodiments, it should be appreciated that the access point(s) can be configured to wirelessly communicate with devices via Wi-Fi communication circuitry.

The network 104 may be embodied as any type of communication network capable of facilitating communication between the various devices of the system 100. As such, the network 104 may include one or more networks, routers, switches, computers, and/or other intervening devices. For example, the network 104 may be embodied as or otherwise include one or more cellular networks, telephone networks, local or wide area networks, publicly available global networks (e.g., the Internet), ad hoc networks, short-range communication links, or a combination thereof.

The server 106 may be embodied as any type of device(s) capable of performing the functions described herein. In the illustrative embodiment, the server 106 may be configured to process data captured by the access control system 102 and/or access control device(s) 110, for example, algorithms, machine learning, artificial intelligence, and/or other techniques. In some embodiments, the access control system 102, access control device(s) 110, and the server 106 may cooperatively perform one or more of the functions of the processing system described herein. For example, in some embodiments, the processing system of the access control system 102 and/or access control device 110 may perform some processing (e.g., less computationally- and/or data-intensive processing), whereas the processing system of the server 106 may perform other processing (e.g., more computationally- and/or data-intensive processing).

It should be further appreciated that the server 106 described herein may be embodied as a cloud-based device or collection of devices within a cloud computing environment. Further, in cloud-based embodiments, the server 106 may be embodied as a server-ambiguous computing solution, for example, that executes a plurality of instructions on-demand, contains logic to execute instructions only when prompted by a particular activity/trigger, and does not consume computing resources when not in use. That is, the server 106 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the server 106 described herein. For example, when an event occurs (e.g., data is transferred to the server 106 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission or analysis of access control data is made (e.g., via an appropriate user interface to the server 106), the appropriate virtual function(s) may be executed to perform the actions before eliminating the instance of the virtual function(s). Embodiments of server 106 in a non-cloud based computing environment are also contemplated.

As described in greater detail below, the access control system 102, the access control device(s) 110 and/or the server 106 may apply various computer algorithms, filters, and/or techniques to generate analysis of access control data. For example, in some embodiments, the mobile device 102 and/or the server 106 may utilize any suitable algorithms useful in determining security assessments and/or anomaly detection analyzing patterns within the access control data collected by system 100. Further, in some embodiments, the access control system 102, the access control device(s) 110 and/or the server 106 may leverage machine learning techniques to perform the functions described herein (e.g., to better ascertain the characteristics of the access control data and/or the usage patterns associated therewith). For example, in some embodiments, the access control system 102, the access control device(s) 110 and/or the server 106 may utilize one or more neural network algorithms, regression algorithms, instance-based algorithms, regularization algorithms, decision tree algorithms, Bayesian algorithms, clustering algorithms, association rule learning algorithms, deep learning algorithms, dimensionality reduction algorithms, and/or other suitable machine learning algorithms, techniques, and/or mechanisms.

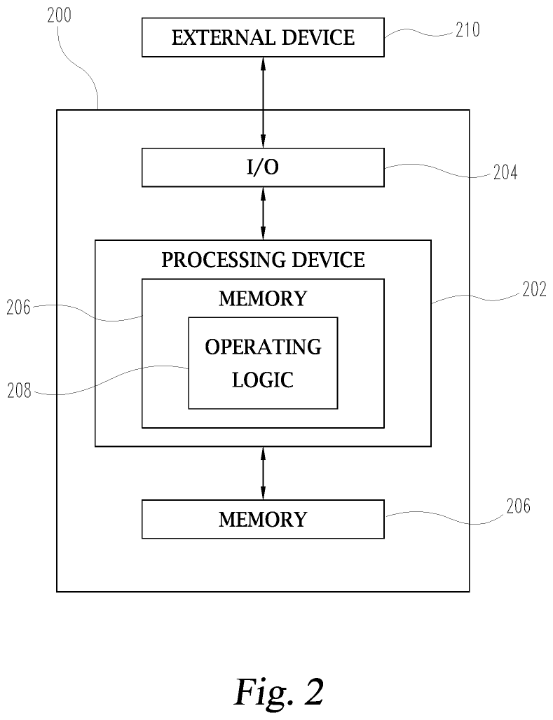

It should be appreciated that each of the access control system 102, the access control device(s) 110 and/or the server 106 may be embodied as a computing device/system similar to the computing system 200 described below in reference to FIG. 2. For example, in the illustrative embodiment, one or more of the access control system 102, the access control device(s) 110, and/or the server 106 may include a processing device 202 and a memory 206 having stored thereon operating logic 208 for execution by the processing device 202 for operation of the corresponding device.

Referring now to FIG. 2, a simplified block diagram of at least one embodiment of a computing system 200 is shown. The illustrative computing system 200 depicts at least one embodiment of an access control system, access control device, and/or server that may be utilized in connection with the access control system 102, access control device 110, and/or the server 106 illustrated in FIG. 1. Depending on the particular embodiment, the computing system 200 may be embodied as a mobile computing device, server, desktop computer, laptop computer, tablet computer, notebook, netbook, Ultrabook™, cellular phone, smartphone, wearable computing device, personal digital assistant, Internet of Things (IOT) device, control panel, router, gateway, and/or any other computing, processing, and/or communication device capable of performing the functions described herein.

The computing system 200 includes a processing device 202 that executes algorithms and/or processes data in accordance with operating logic 208, an input/output device 204 that enables communication between the computing system 200 and one or more external devices 210, and memory 206 which stores, for example, data received from the external device 210 via the input/output device 204.

The input/output device 204 allows the computing system 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing system 200. For example, in various embodiments, the external device 210 may be embodied as the access control system 102, access control device 110, and/or the server 106. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing system 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing system 200 may form a portion of a system-on-a-chip (SoC) and be incorporated on a single integrated circuit chip.

In some embodiments, various components of the computing system 200 (e.g., the processing device 202 and the memory 206) may be communicatively coupled via an input/output subsystem, which may be embodied as circuitry and/or components to facilitate input/output operations with the processing device 202, the memory 206, and other components of the computing system 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing system 200 may include other or additional components, such as those commonly found in a typical computing device (e.g., various input/output devices and/or other components), in other embodiments. It should be further appreciated that one or more of the components of the computing system 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing system 200 may include multiple processing devices 202, I/O devices 204, and/or memories 206 in other embodiments. Further, in some embodiments, more than one external device 210 may be in communication with the computing system 200.

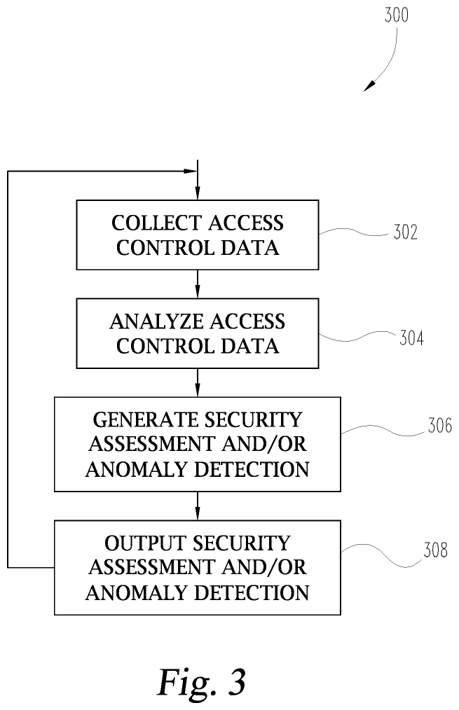

Referring now to FIG. 3, in use, the system 100 (e.g., in conjunction with an administrator request or automatically) may execute a method 300 for analyzing the access control data for security assessments and/or anomaly detection. It should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 302 in which access control system 100 and/or the access control device(s) 110 capture access control data from access control device(s) 110. For example, the access control data may include configuration settings for the system features of each of the access control devices 110, and system wide settings for an access control system 102. The access control data can also include data associated with usage of the access control device(s) 110, including both attempted access events and successful access events were successfully completed by actuation of a locking member at the access control device 102. The access control data may also include access credential usage for credentialed users, user credentials (valid/current and non-valid/expired) associated with access attempts, access credential usage, whether actuation of the access control device occurred virtually or manually (e.g. actuation of thumb-turn), access credential tenure, access credential usage volume, usage history at each access point at the location 108, installation history at the location 108, security score history, and security store stability.

In block 304, the access control data has been transmitted via network 104 to the server 106 for analysis. In the illustrative embodiment, the access control data is transmitted to the server 106 for analysis due to, for example, potentially computationally intensive nature of machine learning and other algorithms for processing the access control data for security assessment and/or anomaly detection. However, it should be appreciated that, in other embodiments, the access control system 102 may include a local server to perform one or more of the analyses described herein in reference to the server 106 (e.g., in conjunction with or in the alternative to the server 106 performing those analyses).

In block 306, the server 106 generates a security assessment and/or anomaly detection in response to the analysis of the access control data. In doing so, the server 106 may analyze the access control data using one or more machine learning and/or artificial intelligence techniques to learn one or more patterns of usage in the access control data. Further, in some embodiments, the server 106 may leverage machine learning and/or artificial intelligence techniques to perform the functions described herein to better ascertain the characteristics and patterns within the access control data. For example, the server 106 may utilize one or more neural network algorithms, regression algorithms, instance-based algorithms, regularization algorithms, decision tree algorithms, Bayesian algorithms, clustering algorithms, association rule learning algorithms, deep learning algorithms, dimensionality reduction algorithms, and/or other suitable machine learning algorithms, techniques, and/or mechanisms.

In block 308, the server 106 outputs the security assessment and/or anomaly detection to an administrator. The output can be provided to the administrator via any suitable mode of communication (e.g., computer application, e-mail and/or text alert to a mobile device or computer, graphical user interface, speaker, tactile feedback, haptic feedback, etc.). The output can allow the user to select one or more actions to be taken in response to the security assessment and/or anomaly detection. For example, the security assessment can include one or more security recommendations that can be selected by the administrator for implementation, such as removing a credentialed user from access to one or more access control devices 110, limiting a credentialed user's access (by location or by time) to one or more locations or within a location, increasing a duration that an access control device 110 is normally locked, pruning access of one or more credentialed users due to inactivity at one or more of the access control devices 110, and pruning inactive users' credentials, among others. In another example, an anomaly detection alert may allow the user to obtain further details regarding the anomaly detection, remotely change a status of an access control device from unlocked to locked or vice versa, contact a user identified in the alert, forward the alert, take other action, or to clear the alert without further action.

It should be appreciated that the security assessment and/or anomaly detection generated by the server 106 based on an analysis of the access control data may vary depending on the particular embodiment. Similarly, the security assessment and/or anomaly detection may vary depending on the particular access control hardware component(s) that are installed at the access points and the unique circumstances for a user's particular location. In some embodiments, the server 106 may generate customized security recommendations and/or anomaly detection based on the analysis of the access control data for the particular location and user preferences. Various examples and use cases of such features are described in greater detail herein. It should be appreciated that the specific examples are provided by way of example only, and the techniques described herein may be used for various other circumstances.

In some embodiments, the server 106 may provide a security assessment that includes a security score indicating a likelihood of unintended access through an access point secured by an access control device 110. The assessment can include a security score comprised of several scoring factors compiled from the analysis of the access control data, such as the configuration of system features, tenure and volume of access privileges at the access point, usage of access privileges at the access point, history of usage of access privileges at the access point, history of securement at the access point, etc.

In some embodiments, the security score can be generated and can be output periodically (e.g. daily, weekly, monthly) to the administrator automatically and/or upon request. The output can be a presentation such as, for example a security score or ranking ranging between a lowest possible score indicating a completely unsecure access point to a highest possible score indicating a completely secure access point. The security score can be generated for each access point at the location, and/or compiled for multiple access points at the location.

In some embodiments, the server 106 may output one or more security recommendations based on the security score. The one or more security recommendations may include, for example, actions the administrator can take to improve security at an access point or across multiple access points. The recommendations may include, for example, increasing an amount of time an access point or access points are locked by the access control device, enabling security notification(s) for anomalies, reviewing access privileges, and/or pruning access privileges. Implementing the recommendations can result in an improved security score in a subsequent security assessment. However, it should be understood that some factors used in developing the security score may not be impacted by the security recommendation implementation, such as the tenure of access privileges, history of installation, usage history at an access point, etc.

In some embodiments, the security score is based on one or more of a system configuration, access privileges tenure, access privileges volume, access privileges usage, usage history at an access point/access control device, installation history, and security score stability. In some embodiments, the security recommendation includes one or more of increasing or changing a locked duration of the access control device(s), time or times at which the access control device(s) are locked, enabling one or more security features, and pruning access privileges.

In some embodiments, the server 106 may output an anomaly detection in response to an analysis of usage patterns in the access control data using passive and/or active learning models. In one embodiment, analysis of existing usage history and audit data for each access control device 102 is employed to detect outlier events or rare occurrences that deviate from common or typical patterns of usage at a particular access point. The server 106 can detect suspicious or out-of-ordinary access control events, or the absence of typically occurring access control events, and provide an output to the user indicating the same. Example anomalies may include intrusion detection, unauthorized access attempts, and identification of absent expected access attempts based on an analysis of behavior patterns per user and/or per access point. Unauthorized access attempts can be identified, for example, by a non-credentialed user or by a credentialed user attempting to obtain access at an unauthorized access point and/or unauthorized time.

In some embodiments, an anomaly is detected in response to a credentialed user using an access control device or credential during an anomalous time, such as a housekeeper, sitter, or other worker using or attempting to use credential during a non-scheduled workday or non-scheduled time. In some embodiments, an anomaly is detected in response to a credentialed user using an access control device or credential after a long absence of use. In some embodiments, an anomaly is detected in response to a credentialed user using an access control device or credential at a non-authorized access point within a location 108. In some embodiments, an anomaly is detected in response to a credentialed user not using an access control device or credential when typically used, such as child user would when returning home after school. In some embodiments, an anomaly is detected in response to a non-credentialed user using an access control device or credential after credential deactivation.

In some embodiments, the anomaly detection includes at least one of detecting access or attempted access by an uncredentialed user at an access point; detecting access or attempted access by a credentialed user at an unauthorized access point; detecting access or attempted access by a credentialed user at an unauthorized time; detecting access or attempted access by a user with expired credentials; detecting a frequency of access or attempted access by a credentialed user; detecting a frequency of access or attempted access by an uncredentialed user; detecting a lack of access or attempted access by a credentialed user at an access point; and detecting a lack of access or attempted access by a credentialed user at a predetermined time.

What is claimed is:

1. A method for evaluating access control data, the method comprising:
collecting access control data from at least one access control device that secures a location;
analyzing the access control data to generate at least one of a security assessment and an anomaly detection for the location based at least in part on usage of the at least one access control device; and
outputting the at least one of the security assessment and the anomaly detection to an administrator of the at least one access control device.

2. The method of claim 1, wherein the analyzing is performed in a cloud-based computing network.

3. The method of claim 1, wherein the at least one access control device includes a plurality of access control devices at the location.

4. The method of claim 3, wherein analyzing the access control data includes analyzing the access control data across the plurality of access control devices.

5. The method of claim 1, wherein analyzing the access control data includes generating the anomaly detection based at least in part on machine learning patterns of usage of the at least one access control device from the access control data.

6. The method of claim 5, wherein the anomaly detection includes at least one of:
detecting access or attempted access by an uncredentialed user at an access point;
detecting access or attempted access by a credentialed user at an unauthorized access point;
detecting access or attempted access by a credentialed user at an unauthorized time;
detecting access or attempted access by a user with expired credentials;
detecting a frequency of access or attempted access by a credentialed user;
detecting a frequency of access or attempted access by an uncredentialed user;
detecting a lack of access or attempted access by a credentialed user at an access point; and
detecting a lack of access or attempted access by a credentialed user at a predetermined time.

7. The method of claim 1, wherein the security assessment includes a security score.

8. The method of claim 7, wherein the security assessment includes a security recommendation.

9. The method of claim 8, wherein the security score is based on one or more of a system configuration, access privileges tenure, access privileges volume, access privileges usage, usage history at an access point/access control device, installation history, and security score stability.

10. The method of claim 9, wherein the security recommendation includes one or more of increasing or changing a locked duration of the access control device(s), enabling one or more security features, and pruning access privileges of credentialed users.

11. A system, comprising:
at least one access control device configured to collect access control data at a location; and
a server comprising a processor and a memory having a plurality of instructions stored thereon that, in response to execution by the processor, causes the server to:
analyze the access control data to generate at least one of a security assessment and an anomaly detection for the location based at least in part on usage of the at least one access control device; and
output the at least one of the security assessment and the anomaly detection to an administrator of the at least one access control device.

12. The system of claim 11, wherein the server is part of a cloud-based computing network.

13. The system of claim 11, wherein the security assessment includes a security score and at least one security recommendation.

14. The system of claim 11, wherein the security score that is based on one or more of a system configuration, access privileges tenure, access privileges volume, access privileges usage, usage history at an access point/access control device, installation history, and security score stability.

15. The system of claim 14, wherein the security recommendation includes one or more of increasing or changing a locked duration of the access control device(s), enabling one or more security features, and pruning access privileges of credentialed users.

16. The system of claim 11, wherein the anomaly detection employs machine learning one or more patterns in the access control data.

17. The system of claim 16, wherein the anomaly detection includes at least one of:
access or attempted access by an uncredentialed user at an access point;
access or attempted access by a credentialed user at an unauthorized access point;
access or attempted access by a credentialed user at an unauthorized time;
access or attempted access by a user with expired credentials;
a frequency of access or attempted access by a credentialed user;
a frequency of access or attempted access by a credentialed user;
a lack of access or attempted access by a credentialed user at an access point; and
a lack of access or attempted access by a credentialed user at a predetermined time.

18. A computer processing device, comprising:
a processor; and
a memory having a plurality of instructions stored thereon that, in response to execution by the processor, causes the processor to:
receive access control data from an access control system at a location;
analyze the access control data to generate at least one of a security assessment and an anomaly detection for the location based at least in part on usage of the access control system; and
output the at least one of the security assessment and the anomaly detection to an administrator of the access control system.

19. The computer processing device of claim 18, wherein the security assessment includes a security score and at least one security recommendation.

20. The computer processing of claim 18, wherein the anomaly detection includes at least one of:
access or attempted access by an uncredentialed user at an access point;
access or attempted access by a credentialed user at an unauthorized access point;
access or attempted access by a credentialed user at an unauthorized time;
access or attempted access by a user with expired credentials;
a frequency of access or attempted access by a credentialed user;
a frequency of access or attempted access by an uncredentialed user;
a lack of access or attempted access by a credentialed user at an access point; and
a lack of access or attempted access by a credentialed user at a predetermined time.
